(19) United States
(12) Patent Application Publication
(10) Pub. No.: US 2010/0126912 A1
(43) Pub. Date: May 27, 2010

(54) SYSTEM AND METHOD FOR SEPARATING MEMBRANES FROM EGGSHELLS

(76) Inventor: Eli Oren, Ramat Hasharon (IL)

Correspondence Address: The Law Office of Michael E. Kondoudis, 888 16th Street, N.W., Suite 800, Washington, DC, 20006, US

(21) Appl. No.: 12/598,426

(22) PCT Filed: May 14, 2008
(86) PCT No.: PCT/IL08/00668

§ 371 Date: Oct. 31, 2009

Related U.S. Application Data
(60) Provisional application No. 60/930,135, filed on May 15, 2007.

(51) Int. Cl. A23L 1/32

(52) U.S. Cl. 209/3.1

(57) ABSTRACT

A system and method for separating membranes from eggshells including a supply conduit supplying eggshells and eggshell membranes, a pulsed energy separation unit receiving the eggshells and eggshell membranes in a liquid medium and applying pulsed energy thereto via the liquid medium, thereby causing separation between the membranes and the eggshells in the liquid medium and allowing the membranes to move relatively upwardly in the liquid medium and the eggshells to move relatively downwardly in the liquid medium and a separator for separating the membranes from the liquid medium.

### REFERENCE TO RELATED APPLICATIONS

This application is related to U.S. Provisional Patent Application Ser. No. 60/930,135, filed May 15, 2007 and entitled METHOD AND APPARATUS FOR SEPARATING EGGSHELL'S MEMBRANE FROM EGGSHELL, the disclosure of which is hereby incorporated by reference and priority of which is hereby claimed pursuant to 37 CFR 1.78(a) (4) and (5)(i).

### FIELD OF THE INVENTION

The present invention relates to separation of membranes from eggshells.

### BACKGROUND OF THE INVENTION

The following published patent documents, the disclosures of which are hereby incorporated by reference, are believed to represent the current state of the art:

U.S. Pat. Nos. 6,649,203 and 3,194,732;

Published PCT Patent Application nos. WO 01/74491; WO 01/66270 and WO 98/41326.

### SUMMARY OF THE INVENTION

The present invention seeks to provide an improved system and methodology for separation of membranes from eggshells.

There is thus provided in accordance with a preferred embodiment of the present invention a system for separating membranes from eggshells including a supply conduit supplying eggshells and eggshell membranes, a pulsed energy separation unit receiving the eggshells and eggshell membranes in a liquid medium and applying pulsed energy thereto via the liquid medium, thereby causing separation between the membranes and the eggshells in the liquid medium and allowing the membranes to move relatively upwardly in the liquid medium and the eggshells to move relatively downwardly in the liquid medium and a separator for separating the membranes from the liquid medium.

Preferably, the system for separating membranes from eggshells also includes a dryer for removing liquid from the eggshells following separation of the membranes therefrom. Additionally or alternatively, the system for separating membranes from eggshells also includes a dryer for removing liquid from the membranes following separation of the eggshells therefrom.

In accordance with a preferred embodiment of the present invention the supply conduit supplies the liquid medium. Preferably, the pulsed energy includes ultrasonic energy.

In accordance with a preferred embodiment of the present invention the pulsed energy is provided by a pulsed energy source. Preferably, the pulsed energy source includes an ultrasonic wave generator coupled to a sonotrode. Alternatively, the pulsed energy source includes an electromagnetic shock wave generator. In another alternative embodiment, the pulsed energy source includes an electro-hydraulic shock wave generator. In yet another embodiment, the pulsed energy source includes a piezoelectric ultrasound transducer.

There is also provided in accordance with another preferred embodiment of the present invention a method for separating membranes from eggshells including supplying eggshells and eggshell membranes, receiving the eggshells and eggshell membranes in a liquid medium and applying pulsed energy thereto via the liquid medium, thereby causing separation between the membranes and the eggshells in the liquid medium and allowing the membranes to move relatively upwardly in the liquid medium and the eggshells to move relatively downwardly in the liquid medium and separating the membranes from the liquid medium.

Preferably, the method for separating membranes from eggshells also includes removing liquid from the eggshells following separation of the membranes therefrom. Additionally or alternatively, the method for separating membranes from eggshells also includes removing liquid from the membranes following separation of the eggshells therefrom.

In accordance with a preferred embodiment of the present invention the supplying eggshells and eggshell membranes includes supplying eggshells and eggshell membranes in the liquid medium.

Preferably, the pulsed energy includes ultrasonic energy.

In accordance with a preferred embodiment of the present invention the pulsed energy is provided by a pulsed energy source. Preferably, the pulsed energy source includes an ultrasonic wave generator coupled to a sonotrode. Alternatively, the pulsed energy source includes an electromagnetic shock wave generator. In another alternative embodiment, the pulsed energy source includes an electro-hydraulic shock wave generator. In yet another embodiment, the pulsed energy source includes a piezoelectric ultrasound transducer.

### BRIEF DESCRIPTION OF THE DRAWING

The present invention will be understood and appreciated more fully from the following detailed description, taken in conjunction with the drawings in which:

FIG. 1 is a simplified illustration of a system and methodology for separation of membranes from eggshells in accordance with a preferred embodiment of the present invention; and

FIG. 2 is a simplified illustration of a system and methodology for separation of membranes from eggshells in accordance with another preferred embodiment of the present invention.

### DETAILED DESCRIPTION OF PREFERRED EMBODIMENTS

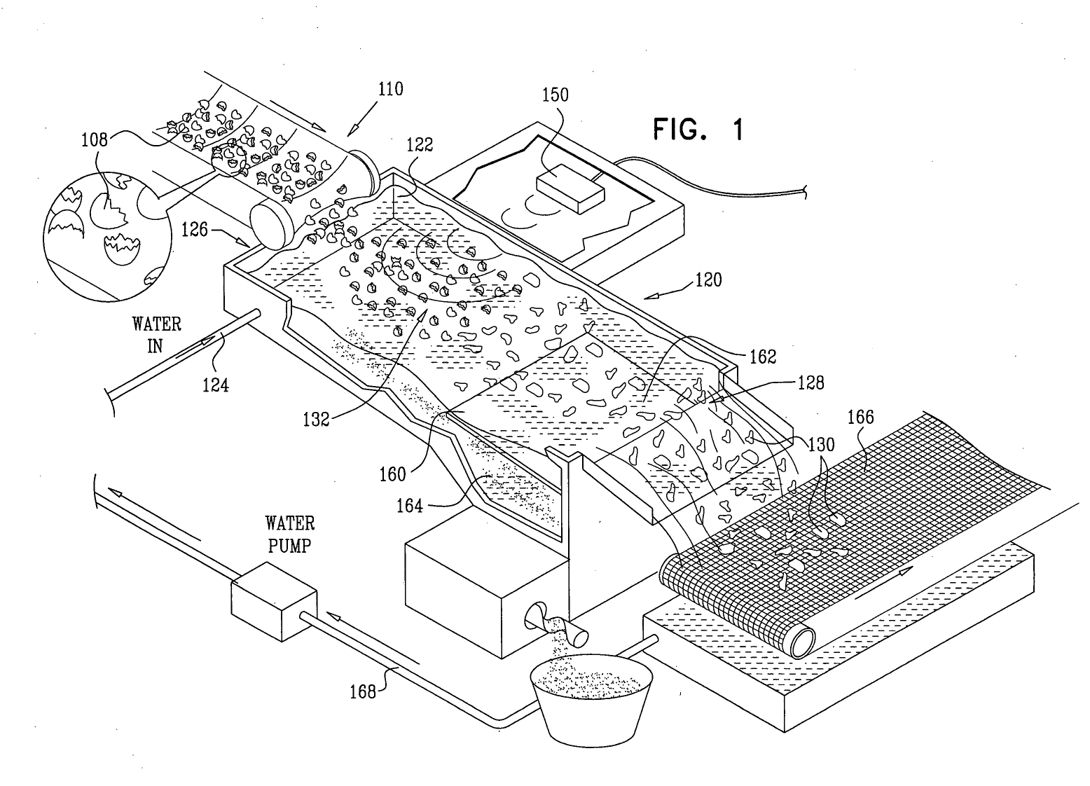

Reference is now made to FIG. 1, which is a simplified illustration of a system and methodology for separation of membranes from eggshells in accordance with a preferred embodiment of the present invention.

As seen in FIG. 1, eggshells including eggshell membranes 108 are supplied, as by a conveyor belt 110, to a pulsed energy separation unit 120, such as a bath containing any suitable liquid 122, preferably water at 30-50 degrees Centigrade. Preferably, liquid 122 is circulated through the unit 120 via a supply conduit 124 and is caused to flow through the unit 120 from a receiving end thereof 126, at which the eggshells and eggshell membranes 108 are supplied thereto, to a separating end thereof 128, at which membranes 130 and eggshells 132 are separated.

In accordance with a preferred embodiment of the present invention, separation of at least partially joined eggshells and eggshell membranes 108 into membranes 130 and eggshells 132 in liquid 122 takes place in unit 120 by means of operation of a pulsed energy source 150, providing application of pulsed energy via the liquid 122 to the at least partially joined eggshells and eggshell membranes 108, producing cavitation of the liquid 122 and creating bubbles which crush eggshells 132 and cause the eggshells 132 to separate from membranes 130.

In accordance with one embodiment of the present invention, the pulsed energy source may comprise an ultrasonic wave generator, preferably an ultrasonic wave generator commercially available from Hielscher Ultrasonics GmbH, Teltow, Germany, which may be coupled to a sonotrode, preferably a sonotrode commercially available from Hielscher Ultrasonics GmbH, Teltow, Germany.

In accordance with another embodiment of the present invention, the pulsed energy source may comprise an electromagnetic shock wave generator, such as a Dornier Doli S commercially available from Dornier MedTech of Wessling, Germany, Siemens Lithostar commercially available from Siemens AG of Munich, Germany, or a Storz Modulith commercially available from Storz Medical AG of Tagerwilen, Switzerland.

In accordance with yet another embodiment of the present invention, the pulsed energy source may comprise an electro-hydraulic shock wave generator, such as a Dornier HM-3, Medstone STS-T commercially available from Medstone International inc. of Aliso Viejo, Calif., USA, Direx Tripter Compact commercially available from Direx Systems Corp., Canton, Mass., USA and Medispec Econolith commercially available from Medispec LTD., Germantown, Md., USA.

In accordance with still another embodiment of the present invention, the pulsed energy source may comprise a piezoelectric ultrasound transducer, such as a High Intensity Focused Ultrasound transducer, preferably but not limited to an InSightec Exhablate commercially available from Insightec Ltd., Tirat Carmel, Israel.

In accordance with a preferred embodiment of the present invention, once the membranes 130 are separated from the eggshells 132, the membranes 130 tend to rise in the liquid 122, while the eggshells 132 tend to fall in the liquid 122. Thus by use of a separation element 160, an upper portion 162 of the liquid 122, containing the membranes 130, may be separated from a lower portion 164 of the liquid 122, containing the eggshells 132.

The upper portion 162 of the liquid containing the membranes 130 may be supplied to a draining conveyor 166 which allows the liquid 122 to drain therefrom and be recycled to the unit 120 via a conduit 168. The membranes 130 may then be dried and used, for example for cosmetics, therapeutics and nutraceuticals.

The eggshells 132 may be strained from the lower portion 164 of the liquid and may be crushed and used for any suitable purpose.

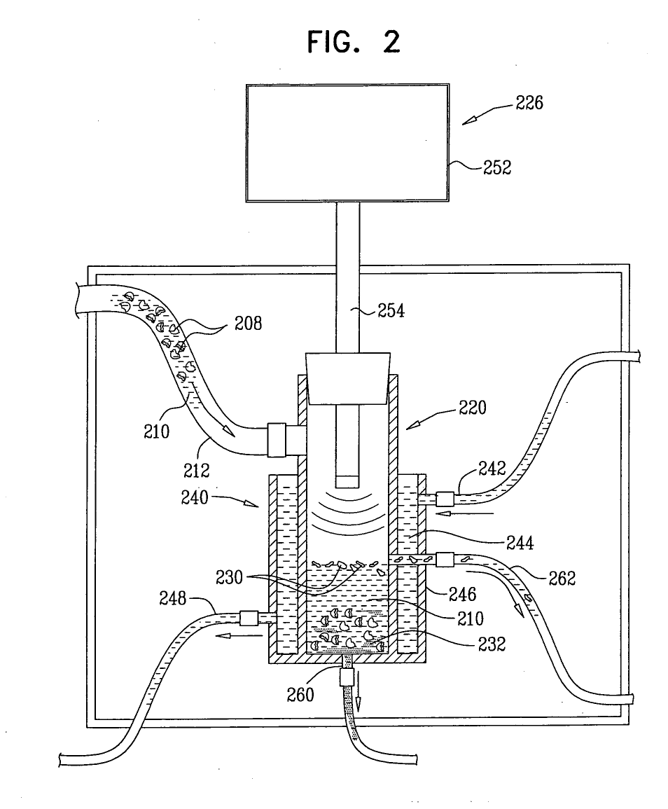

Reference is now made to FIG. 2, which is a simplified illustration of a system and methodology for separation of membranes from eggshells in accordance with another preferred embodiment of the present invention.

As seen in FIG. 2, eggshells including eggshell membranes 208 are supplied, together with a liquid 210, preferably water at 30-50 degrees Centigrade, as by an input conduit 212, to a pulsed energy separation unit 220. Pulsed energy is supplied to pulsed energy separation unit 220 by a pulsed energy source 226.

In accordance with a preferred embodiment of the present invention, separation of at least partially joined eggshells and eggshell membranes 208 into membranes 230 and eggshells 232 in liquid 210 takes place in pulsed energy separation unit 220 by means of operation of pulsed energy source 226, providing application of pulsed energy via the liquid 210 to the at least partially joined eggshells and eggshell membranes 208, producing cavitation of the liquid 210 and creating bubbles which crush eggshells 232 and cause the eggshells 232 to separate from membranes 230.

The system of FIG. 2 also preferably includes a cooling liquid circulation subsystem 240 to ensure that pulsed energy separation unit 220 does not overheat. Cooling liquid circulation subsystem preferably includes an input conduit 242 providing a cooling liquid 244, preferably water, to an outer container 246 encasing pulsed energy separation unit 220, and an output conduit 248.

In the illustrated embodiment of the present invention, the pulsed energy source 226 comprises an ultrasonic wave generator 252, preferably an ultrasonic wave generator commercially available from Hielscher Ultrasonics GmbH, Teltow, Germany, coupled to a sonotrode 254, preferably a sonotrode commercially available from Hielscher Ultrasonics GmbH, Teltow, Germany.

In accordance with another embodiment of the present invention, the pulsed energy source may comprise an electromagnetic shock wave generator, such as a Dornier Doli S commercially available from Dornier MedTech of Wessling, Germany, Siemens Lithostar commercially available from Siemens AG of Munich, Germany, or a Storz Modulith commercially available from Storz Medical AG of Tagerwilen, Switzerland.

In accordance with yet another embodiment of the present invention, the pulsed energy source may comprise an electro-hydraulic shock wave generator, such as a Dornier HM-3, Medstone STS-T commercially available from Medstone International inc. of Aliso Viejo, Calif., USA, Direx Tripter Compact commercially available from Direx Systems Corp., Canton, Mass., USA and Medispec Econolith commercially available from Medispec LTD., Germantown, Md., USA.

In accordance with still another embodiment of the present invention, the pulsed energy source may comprise a piezoelectric ultrasound transducer, such as a High Intensity Focused Ultrasound transducer, preferably but not limited to an InSightec Exhablate, commercially available from Insightec Ltd., Tirat Carmel, Israel.

In the illustrated embodiment of the present invention, once the membranes 230 are separated from the eggshells 232, the eggshells 232 tend to fall in liquid 210 to the bottom portion of pulsed energy separation unit 220 and exit via first outflow conduit 260, while the membranes 230 tend to rise in the liquid 210 and exit via second outflow conduit 262.

The outflow from second outflow conduit 262 containing the membranes 230 is preferably supplied to a draining conveyor (not shown) which allows the liquid 210 to drain therefrom. The membranes 230 may then be dried and used, for example for cosmetics, therapeutics and nutraceuticals.

The eggshells 232 exiting via first outflow conduit 260 may be used for any suitable purpose.

It will be appreciated by persons skilled in the art that the present invention is not limited to what has been particularly shown and described hereinabove. Rather the scope of the present invention includes both combinations and sub-combinations of the various features described and shown hereinabove and modifications thereof which will occur to persons skilled in the art upon reading the foregoing description and which are not in the prior art.

1. A system for separating membranes from eggshells comprising:
a supply conduit supplying eggshells and eggshell membranes;
a pulsed energy separation unit receiving said eggshells and eggshell membranes in a liquid medium and applying pulsed energy thereto via said liquid medium, thereby causing separation between said membranes and said eggshells in said liquid medium and allowing said membranes to move relatively upwardly in said liquid medium and said eggshells to move relatively downwardly in said liquid medium; and
a separator for separating said membranes from said liquid medium.

2. A system for separating membranes from eggshells according to claim 1, and also comprising a dryer for removing liquid from said eggshells following separation of said membranes therefrom.

3. A system for separating membranes from eggshells according to claim 1 and also comprising a dryer for removing liquid from said membranes following separation of said eggshells therefrom.

4. A system for separating membranes from eggshells according to claim 1 and wherein said supply conduit supplies said liquid medium.

5. A system for separating membranes from eggshells according to claim 1 and wherein said pulsed energy comprises ultrasonic energy.

6. A system for separating membranes from eggshells according to claim 1 and wherein said pulsed energy is provided by a pulsed energy source.

7. A system for separating membranes from eggshells according to claim 6 and wherein said pulsed energy source comprises an ultrasonic wave generator coupled to a sonotrode.

8. A system for separating membranes from eggshells according to claim 6 and wherein said pulsed energy source comprises an electromagnetic shock wave generator.

9. A system for separating membranes from eggshells according to claim 6 and wherein said pulsed energy source comprises an electro-hydraulic shock wave generator.

10. A system for separating membranes from eggshells according to claim 6 and wherein said pulsed energy source comprises a piezoelectric ultrasound transducer.

11. A method for separating membranes from eggshells comprising:
supplying eggshells and eggshell membranes;
receiving said eggshells and eggshell membranes in a liquid medium and applying pulsed energy thereto via said liquid medium, thereby causing separation between said membranes and said eggshells in said liquid medium and allowing said membranes to move relatively upwardly in said liquid medium and said eggshells to move relatively downwardly in said liquid medium; and
separating said membranes from said liquid medium.

12. A method for separating membranes from eggshells according to claim 11 and also comprising removing liquid from said eggshells following separation of said membranes therefrom.

13. A method for separating membranes from eggshells according to claim 11 and also comprising removing liquid from said membranes following separation of said eggshells therefrom.

14. A method for separating membranes from eggshells according to claim 11 and wherein said supplying eggshells and eggshell membranes comprises supplying eggshells and eggshell membranes in said liquid medium.

15. A method for separating membranes from eggshells according to claim 11 and wherein said pulsed energy comprises ultrasonic energy.

16. A method for separating membranes from eggshells according to claim 11 and wherein said pulsed energy is provided by a pulsed energy source.

17. A method for separating membranes from eggshells according to claim 16 and wherein said pulsed energy source comprises an ultrasonic wave generator coupled to a sonotrode.

18. A method for separating membranes from eggshells according to claim 16 and wherein said pulsed energy source comprises an electromagnetic shock wave generator.

19. A method for separating membranes from eggshells according to claim 16 and wherein said pulsed energy source comprises an electro-hydraulic shock wave generator.

20. A method for separating membranes from eggshells according to claim 16 and wherein said pulsed energy source comprises a piezoelectric ultrasound transducer.
